(19) United States
(12) Patent Application Publication
(10) Pub. No.: US 2006/0040828 A1
(43) Pub. Date: Feb. 23, 2006

(54) Biologically active formulation containing polyethyleneimine and its derivatives

(76) Inventors: Jianhua Mao, West Chester, OH (US); Timothy Anderson, Hamilton, OH (US)

Correspondence Address: COGNIS CORPORATION;PATENT DEPARTMENT, 300 BROOKSIDE AVENUE, AMBLER, PA, 19002, US

(21) Appl. No.: 11/200,909

(22) Filed: Aug. 10, 2005

Related U.S. Application Data
(60) Provisional application No. 60/602,406, filed on Aug. 18, 2004.

(51) Int. Cl. A01N 25/16; A01N 25/04

(52) U.S. Cl. 504/365; 424/405

(57) ABSTRACT

A pesticide composition containing: (a) a polyaliphatic amine and/or its derivative; and (b) a biologically active component selected from the group consisting of insecticides, insect repellents, fungicides, bactericides, bacteriostats, herbicides, plant growth regulators, and mixtures thereof.

### CROSS-REFERENCE TO RELATED APPLICATIONS

This application claims priority from copending Provisional Application No. 60/602,406 filed Aug. 18, 2004.

### STATEMENT REGARDING FEDERALLY SPONSORED RESEARCH OR DEVELOPMENT

Not applicable.

### BACKGROUND OF THE INVENTION

The present invention generally relates to adjuvants for agricultural products. More particularly, the invention relates to a novel adjuvant which, when used in combination with a pesticide product containing a biologically active ingredient, significantly enhances the performance of the pesticide product with respect to emulsification, wetting, rain-fastness and dispersing.

It is known that various agricultural materials such as insecticides, insect repellents, fungicides, bactericides, herbicides, and plant growth regulators may be formulated into various products for use on crops, seed, and ornamental plants, for controlling weeds, insects and the like. These products may be applied in the form of a liquid, wettable powder, dispersible granule or a semi-solid dispersion. Regardless of the method of application, it is advantageous to include within the product an adjuvant in order to enhance the effectiveness and performance of the agricultural product's actives, thereby requiring less active ingredients to be used to perform a certain function.

While the use and application of pesticide products with supporting adjuvant products is generally known, their formulation into a single, yet compatibly soluble, enhanced pesticide product poses various stability problems. Due to the chemical dissimilarities associated with the individual components which make up a pesticide product and its adjuvant, it is oftentimes not possible to effectively disperse each of the individual components into a single formulation.

Thus, it is a primary object of the present invention to provide an adjuvant which both enhances the effectiveness of a biologically active compound and remains stable during storage, when combined in the spray tank mixture or as a single product combined with an active ingredient prior to its application.

Another problem associated with the use of many agrochemicals relates to the presence of high levels of metal ions contained in the tap or well water commonly used to dilute the pesticide concentrate prior to application. The presence of these ions can reduce the effectiveness of biologically active ingredients, particularly with respect to salts of the herbicide Glyphosate, due to the formation of metal ion complexes with the active. A common method of dealing with this phenomenon is to add a sequestering agent, such as ammonium sulfate, in order to overcome the negative impact caused by said metal ions. It would be highly desirable, however, to be able to avoid the use of sequestering agents which add cost to the formulation and add to the solubility concerns of the final product.

Finally, large amounts of agrochemicals are typically applied onto a target substrate in the form of fine liquid droplets. The size and distribution of the droplets are important parameters associated with the application process for droplets which are too small, i.e., less than 100 μm, might drift away from the intended area. Drifting agrochemical sprays not only result in an increased usage of product, but are also potentially hazardous to humans and the environment. On the other hand, droplet sizes of greater than 400 μm cause uneven distribution of the pesticide product, thus reducing the overall effectiveness of the product. In an effort to overcome these disadvantages, polymeric drift control agents are typically used. It would, however, be highly desirable to be able to avoid the use of any additional drift control agents while at the same time being able to overcome the above-disclosed disadvantages.

### SUMMARY OF THE INVENTION

The present invention is directed to a biologically active composition containing:

(a) a polyaliphatic amine and/or its derivative of the formula I: 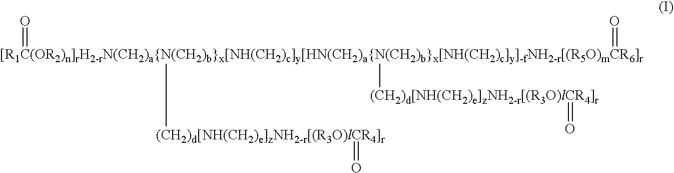
wherein R₁, R₄ and R₆, independently, represent hydrogen or a C₁-C₃₀ alkyl or alkenyl group; (OR₂)ₙ, (OR₃)ₗ and (OR₅)ₘ, independently, represent a random polyalkoxide group, or a block polyalkoxide group; R₂, R₃ and R₅, independently, represent a C₂-C₆ alkyl group; n, m and l, independently, represent a number up to 100, r is a number up to 2; a, b, c, d and e, independently, represent a number from 1-12, x, y and z represent a number up to 100; and f is a number from 0-49,999.

(b) a biologically active component selected from the group consisting of insecticides, insect repellents, fungicides, bactericides, bacteriostats, herbicides, plant growth regulators, and mixtures thereof;

(c) optionally carriers and auxiliaries.

There is also provided a process for treating a target substrate involving contacting the substrate with the above-disclosed biologically active composition.

### DESCRIPTION OF THE INVENTION

Other than in the claims and in the operating examples, or where otherwise indicated, all numbers expressing quantities of ingredients or reaction conditions used herein are to be understood as modified in all instances by the term “about”.

It has surprisingly been found that the use of a polyaliphatic amine and/or its derivatives in pesticide formulations, particularly those employing glyphosate as a biologically active ingredient, increases the area per volume of liquid covered by the pesticide, helps the active ingredient to wet out on the surface of the substrate being treated, helps penetrate the leaf barrier and/or the protective coating of an insect. The polyalphatic amine and/or its derivative also serve to sequester metal ions which may be present, thereby eliminating the need for the use of conventional sequestering agents. Finally, it has also been surprisingly discovered that the polyaliphatic amines and their derivatives also effectively control the drift of sprayed liquid droplets of the ready-to-use pesticide product by controlling the size of the droplets being sprayed onto a target area, thereby eliminating the need for the use of drift control agents. In addition, the polyaliphatic amine of the invention improves the main features of the pesticide.

The polyaliphatic amines and/or their derivatives are generally represented by formula I: 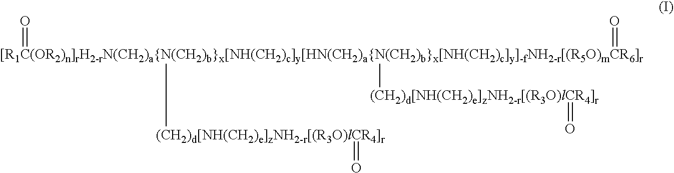
wherein R₁, R₄ and R₆, independently, represent hydrogen or a C₁-C₃₀ alkyl or alkenyl group; (OR₂)ₙ, (OR₃)ₗ and (OR₅)ₘ, independently, represent a random polyalkoxide group, or a block polyalkoxide group; R₂, R₃ and R₅, independently, represent a C₂-C₆ alkyl group; n, m and l, independently, represent a number up to 100, r is a number up to 2; a, b, c, d and e, independently, represent a number from 1-12, x, y and z represent a number up to 100 and f is a number from 0 to 49,999. They are typically derived from the reaction of a polyaliphatic amine with an alkylene oxide and/or organic acids. A particularly preferred polyaliphatic amine for use in the present invention is a polyethyleneimine of the formula: 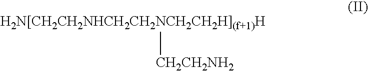
wherein (f+1) is a number from 1 to 50,000. Preferably f is a number of from 0 to 100.

The biologically active materials which can be used to make compositions according to the invention include, but are not limited to, insecticides such as O,O-diethyl O-(2-isopropyl-4-methyl-6-pyrimidinyl)phosphorothioate, O,O-diethyl S-2-[(ethylthio)ethyl]phosphorodithioate, O,O-dimethyl O-(3-methyl-4-nitrophenyl)thiophosphate, O,O-dimethyl S-(N-methylcarbamoyl methyl)phosphorodithioate, O,O-dimethylS-(N-methyl-N-formylcarbamoylmethyl)phosphorodithioate, O,O-dimethyl S-2-[(ethylthio)ethyl]phosphorodithioate, O,O-diethyl S-2-[(ethylthio)ethyl]phosphorodithioate, O,O-dimethyl-1-hydroxy-2,2,2-trichloroethylphosphonate, O,O-diethyl-O-(5-phenyl-3-isooxazolyl )phosphorothioate, O,O-dimethyl O-(2,5-dichloro-4-bromophenyl)phosphorothioate, O,O-dimethyl-O-)3-methyl-4-methylmercaptophenyl)thiophosphate, O-ethyl O-p-cyanophenyl-O-phenylphosphorothioate, O,O-dimethyl-S-(1,2-dicarboethoxyethyl)phosphorod ithioate, 2-chloro-(2,4,5-trichlorophenyl)vinyldimethyl phosphate, 2-chloro-l-(2,4-dichlorophenyl)vinyldimethyl phosphate, O,O-dimethyl O-p-cyanophenyl phosphorothioate, 2,2-dichlorovinyl dimethyl phosphate, O,O-diethyl O-2,4-dichlorophenyl phosphorothioate, ethyl mercaptophenylacetate O,O-dimethyl phosphorodithioate, S-[(6-chloro-2-oxo-3-benzooxazolinyl)methyl]O,O-diethyl phosphorodithioate, 2-chloro-1-(2,4-dichlorophenyl)vinyl diethylphosphate O,O-diethyl O-(3-oxo-2-phenyl-2H-pyridazine-6-yl)phosphorothioate, O,O-dimethyl S-(1-methyl-2-ethylsulfinyl )-ethyl phosphorothiolate, O,O-dimethyl S-phthalimidomethyl phosphorodithioate, O,O-diethyl 2,2,2-trichloroethanol, 2-(p-tert-butyl-phenoxy)isopropyl-2′-chloroethylsulfite, azoxybenzene, di-(p-chlorophenyl)-cyclopropyl carbinol, di[tri(2,2-dimethyl-2-phenylethyl)tin]oxide, 1-(4-chlorophenyl)-3-(2,6-difluorobenzoyl)urea and S-tricyclohexyltin O,O-diisopropylphosphorodithioate; 2-methyl-2-(methylthio)propionaldehyde O-(mehtylcarbamoyl)oxime; ethyl [2-(4-phenoxyphenoxy)ethyl] carbamate; butyl-2,3-dihydro-2,2-dimethylbenzofuran-7-yl N,N′-dimethyl-N,N′-thiodicarbamate; 1-naphthyl methyl carbamate; 2-(ethylthiomethyl)phenyl methylcarbamate; 5-(4-phenoxybutyl)dimethylthiocarbamate; dimethyl N,N′-(thiobis(methylimino)carbonyloxy)-bis(ethanimidothioate); (RS)-α-cyano-3-phenoxybenzyl-(RS)-2-(4-chlorophenyl)-3-methylbutyrate; (RS)-α-cyano-3-phenoxyphenyl-(RS)-2,2-dichloro-1-(4-ethoxyphenyl)cyclopropanecarboxylate; (RS)-a-cyano-3-phenoxybenzyl-N-(2-chloro-α,α,α-trifluoro-p-tolyl-D-valinate; 3-phenoxybenzyl-(1 RS)-cis,trans-3-(2,2-dichlorovinyl)-2,2-diemthylcyclopropanedicarboxylate.

Insect repellents which may also be employed include but are not limited to 2-ethyl-1,3-hexanediol; N-octyl bicycloheptene dicarboximide; N,N-diethyl-M-toluamide; 2,3:4,5-Bis (2-butylene) tetrahydro-2-furaldehyde; Di-n-propyl isocinchomeronate; and 2-hydroxyethyl-n-octyl sulfide.

Fungicides which may also be employed include but are not limited to 3,3′-ethylenebis (tetrahydro-4,6-dimethyl-2H-1,3,5-thiadiazine-2-thione), zinc or manganese ethylenebis(dithiocarbamate), bis-(dimethyldithiocarbamoyl)disulfide, zinc propylenebis (dithiocarbamate), bis(dimethyldithiocarbamoyl) ethylenediamine; nickel dimethyldithiocarbamate, methyl-1(butylcarbamoyl)-2-benzimidazolecarbamate, 1,2-bis(3-methoxycarbonyl-2-thioureido)benzene, 1-isopropylcarbamoyl-3-(3,5-dichlorophenyl)hydantoin, potassium N-hydroxymethyl-N-methyidithiocarbamate and 5-methyl-10-butoxycarbonylamino-10,11-dehydrodibenzo (b,f)azepine; pyridine fungicides such as zinc bis(i -hydroxy-2(1H)pyridinethionate and 2-pyridinethiol-1-oxide sodium salt; O,O-diisopropyl S-benzylphosphorothioate and O-ethyl S,S-diphenyldithiophosphate; phthalimide fungicides such as N-(2,6-p-diethylphenyl)phthalimide and N-(2,6-diethylphenyl)-4-methylphthalimide; dicarboxyimide fungicides such as N-trichloromethylthio 4-cyclohexene-1,2-dicarboxyimide and N-tetrachloroethylthio-4-cyclohexene-1,2-dicarboxyimide; 5,6-dihydro-2-methyl-1,4-oxathine-3-carboxanilido-4,4-dioxide and 5,6-dihydro-2-methyl-1,4-oxathine-3-carboxanilide; naphthoquinone fungicides such as 2,3-dichloro-1,4-naphthoquinone, 2-oxy-3-chloro-1,4-naphthoquinone copper sulfate, pentachloronitrobenzene; 1,4-dichloro-2,5-dimethoxybenzene; 5-methyl-s-triazol-(3,4-b)benzthiazole; 2-(thiocyanomethylthio)benzothiazole; 3-hydroxy-5-methylisooxazole; N-2,3-dichlorophenyltetrachlorophthalamic acid; 5-ethoxy-3-trichloromethyl-1,2,4-thiaziazole; 2,4-dichloro-6-(O-chloroanilino)-1,3,5-triazine; 2,3-dicyano-1,4-dithioanthraquinone; copper 8-quinolinate; polyoxine; validamycin; cycloheximide; iron methanearsonate; diisopropyl 1,3-dithiolane-2-iridene malonate; 3-allyloxy-1,2-benzoisothiazol-1,1-dioxide; kasugamycin; Blasticidin S; 4,5,6,7-tetrachlorophthalide; 3-(3,5-dichlorophenyl)5-ethenyl5-methyloxazolizine-2,4-dione; N-(3,5-dichlorophenyl)-1,2-dimethylcyclopropane-1,2-dicarboxyimide; S-n-butyl-5′-para-t-butylbenzyl-N-3-pyridyldithiocarbonylimidate; 4-chlorophenoxy-3,3-dimethyl-1-(1H ,1,3,4-triazol-1-yl)-2-butanone; methyl-D,L-N-(2,6-dimethylphenyl)-N-(2′-methoxyacetyl)alaninate; N-propyl-N-[2-(2,4,6-trichlorophenoxy)ethyl]imidazol-1-carboxamide; N-(3,5-dichlorophenyl)succinamide; tetrachloroisophthalonitrile; 2-dimethylamino-4-methyl-5-n-butyl-6-hydroxypyrimidine; 2,6-dichloro-4-nitroaniline; 3-methyl-4-chlorobenzthiazol-2-one; 1,2,5,6-tetrahydro-4H-pyrrolol-[3,2,1-i,j]quinoline-2-one; 3′-isopropoxy-2-methylbenzanilide; 1-[2-(2,4-dichlorophenyl)-4-ethyl-1,3-dioxorane-2-ylmethyl]-1H,1,2,4-triazol; 1,2-benzisothiazoline-3-one; basic copper chloride; basic copper sulfate; N′-dichlorofluoromethylthio-N,N-dimethyl-N-phenyl sulfamide; ethyl-N-(3-dimethylaminopropyl)thiocarbamate hydrochloride; piomycin; S,S-6-methylquinoxaline-2,3-di-yldithiocarbonate; complex of zinc and manneb; di-zinc bis(dimethyidithiocarbamate)ethylenebis (dithiocarbamate).

Plant growth regulators which may also be employed include but are not limited to N-methoxycaronyl-N′-4-methylphenylcarbamoylethylisourea and 1-(4-chlorophenylcarbamoyl)-3-ethoxycarbonyl-2-methylisourea; another type of plant growth regulators such as sodium naphthaleneacetate, 1,2-dihydropyridazine-3,6-dione and gibberellins; traizine herbicides such as 2-methylthio-4,6-bisethylamino-1,3,5-triazine, 2-chloro-4,6-bisethylamino-1,3,5-triazine, 2-methoxy-4-ethylamino-6-isopropylamino-1,3,5-triazine, 2-chloro-4-ethylamino-6-isopropylamino-s-triazine, 2-methylthio-4,6-bis(isopropylamino)-S-triazine and 2-methylthio-4-ethylamino-6-isopropylamino-s-triazine; phenoxy herbicides such as 2,4-dichlorophenoxyacetic acid and methyl, ethyl, and butyl esters thereof. 2-chloro-4-methylphenoxyacetic acid, 4-chloro-2-methylphenoxyacetic acid and ethyl 2-methyl-4-chlorophenoxybutylate; diphenylether herbicides such as 2,4,6-trichlorophenyl-4′-nitrophenylether,2,4-dichlorophenyl-4′-nitrophenylether and 3,5-dimethylphenyl-4′-nitrophenylether; urea herbicides such as 3-(3,4-dichlorophenyl)-1-methoxy-1-methyl urea, 3-(3,4-dichlorophenyl)-1,1-dimethylurea and 3-(4-chlorophenyl)-1,1-dimethyl urea; carbamate herbicides such as 3-methoxycarbonylaminophenyl-N-(3-methylphenyl)carbamate, isopropyl-N-(3-chlorophenyl)carbamate and methyl-N-(3,4′-dichlorophenyl)carbamate; uracil herbicides such as 5-bromo-3-sec-butyl-6-methyluracil and 1-cyclohexyl-3,5-propyleneuracil; thiolcarbamate herbicides such as S-(4-chlorobenzyl)-N,N-diethylthiolcarbamate,S-ethyl-N-cyclohexyl-N-ethylthiolcarbamate and S-ethyl-hexahydro-1H-azepine-1-carbothioate and S-ethyl-N,N-di-n-propyl-thiocarbamate; pyridinium herbicides such as 1,1′-di-methyl-4,4′-bispyridinium dichloride; phosphorus-containing herbicides such as N-(phosphonomethyl)glycine; aniline herbicides such as alpha, alpha, alpha-trifluoro-2,6-dinitro-N,N-dipropyl-p-toluidine, 4-(methylsulfonyl)-2,6-dinitro-N,N-dipropylaniline and N[3], N[3]-diethyl-2,4-dinitro-6trifluoromethyl-1,3-phenylene diamine; acid anilide herbicides such as 2-chloro-2′,6′-diethyl-N-(butoxymethyl)acetoanilide, 2-chloro-2′,6′-diethyl-N-(methoxymethyl)acetoanilide, and 3,4-dichloropropioneanilide; pyrazole herbicides such as 1,3-dimethyl-4-(2,4-dichlorobenzoyl)-5-hydroxypyrazole and 1,3-di-methyl-4-(2,4-dichlorobenzoyl)-5-(p-toluenesulfonyloxy)pyrazole; 5-tert-butyl-3-(2,4-dichloro-5-isopropoxyphenyl)-1,3,4-oxadiazoline-2-one; 2-[N-isopropyl,N-(4-chlorophenyl)carbamoyl]-4-chloro-5-methyl-4-isooxazoline-3-one; 3-isopropylbenzo-2-thia-1,3-diazinone-(4)-2,4-dioxide and 3-(2-methyl-phenoxy)pyridazine.

A particularly preferred biologically active ingredient for use in the present invention is a liquid-dispersible phytoactive N-phosphonomethyl-N-carboxymethyl compound as defined in U.S. Pat. No. 5,468,718, the entire contents of which are hereby incorporated by reference. An especially preferred liquid-dispersible phytoactive N-phosphonomethyl-N-carboxymethyl compound is glyphosate and, particularly, a potassium and amine salts of glyphosate.

In one embodiment of the present invention there is provided a pesticide product concentrate containing from about 1 to about 40%, preferably from about 4 to about 25% by weight, and most preferably from about 7 to about 10% by weight, of a polyaliphatic amine or derivative thereof, preferably a polyethyleneimine, in combination with from about 3 to about 95%, preferably from about 20 to about 80% by weight, and most preferably from about 30 to about 65% by weight of a biologically active ingredient, the remaining components comprising a carrier and auxiliaries. The adjuvant of the invention is particularly useful as an adjuvant for glyphosate. The biologically active component may be applied to the locus of the pests at a concentration in the range of from 0.0001% by weight to 9.5% by weight in a mixture comprising the adjuvant of the invention and water as a carrier. Preferably at a concentration in the range of 0.0001% by weight to 3.5% by weight, and most preferably in a range of 0.0015% to 1.5% by weight of the biologically active component.

While the polyaliphatic amine may be used alone in pesticide products containing a biologically active ingredient, it should be noted that other co-adjuvants and auxiliaries may also be employed in order to provide further desired adjuvant affects.

The present invention also provides a process for treating an agricultural substrate by contacting it with the above-disclosed pesticide product. The term agricultural substrate as used herein means a plant, a plant pest, or a combination of a plant and a plant pest. A plant pest is defined as any living stage of any insects, mites, nematodes, slugs, snails, protozoa, or other invertebrate animals, bacteria, fungi, other parasitic plants or reproductive parts thereof, viruses, or any organisms similar to or allied with any of the foregoing, or any infectious substances which can directly or indirectly injure or cause disease or damage in any plants or parts thereof, or any processed, manufactured, or other products of plants.

The use of polyaliphatic amines in pesticide products results in a number of benefits being realized. One such benefit is the potentiation of the biologically active ingredient contained in the pesticide product so that it performs more effectively. Yet another benefit is that the use of polyaliphatic amines in a pesticide product also eliminates the need for employing any sequestering agents and/or drifting agents, in combination with the product, since problems associated with the use of such additives are avoided by the presence of the polyaliphatic amines within the pesticide product. Another benefit is an improvement in the rain-fastness of the biologically active component.

The present invention will be better understood from the examples which follow, all of which are intended to be illustrative only and are not meant to limit the scope of the invention. Unless otherwise indicated, percentages are on a weight-by-weight basis.

The composition of the invention may contain carriers and auxiliaries. Generally the carrier is water in dilute formulations but can comprise solvents for the biologically active solids or solids which carry the biologically active component in a water dispersible powder form. When the carrier is a solvent for the biologically active component, the mixture is generally emulsifiable in water to form a dilute dispersion which is applied to the locus of the pest to be controlled.

Auxiliaries may be present in the composition of the invention. The auxiliaries may include coemulsifiers, stabilizers, potentiators which affect the efficacy of the pesticide, sticking agents, spreading agents, solubilizers and other materials which are added to pesticide formulations to modify properties of the formulation or the pesticide.

The carriers and auxiliaries are well known to those skilled in the art.

The composition of the invention can be prepared as a concentrate which is diluted for application to the locus of the pest to be controlled. In an alternate method, the polyalkyleneimine and/or derivative is added to a tank mix of the biologically active component or introduced with other materials into the tank mix. The tank mix is a dilute mixture of the biologically active material in a carrier and is generally applied directly to the locus of the pest to be controlled.

Biologically active concentrates are generally mixtures of a biologically active components with adjuvants which are diluted, preferably with water, to form a dilute mixture for application to the locus of the pest to be controlled. However, dilute biologically active formulations can be prepared using diluents other than water. The diluent used is dependent upon the pesticide and the locus of the pests.

Biologically active components can be formulated as a wettable powder with or without an insoluble carrier which is dispersed in water then applied to the locus of the pest to be controlled. These formulations require dispersing agents, stabilizers and other additives known in the art of pesticide formulations.

The composition of the invention as applied to the locus may have a concentration of the polyalkylene amine or derivative thereof of from 0.0001% to 4.0% by weight, preferably from 0.004% to 2.5% by weight and more preferably from 0.01% to 1.0% by weight.

The present invention is base on the unexpected discovery that polyethyleneimines and their derivatives as disclosed herein can beneficially affect biological activity when applied as a mixture with a biologically active component.

### EXAMPLES

### Example 1

### Preparation of a Polyethylene Fatty Acid Amide

390 g of polyethyleneimine (0.300 mol), LUPASOLI G [FM=1300] (a product from BASF), was placed into a 1-L 4-necked flask, which was equipped with a thermometer, a mechanical stirrer, an addition funnel and a condenser. The flask was heated to about 75° C. 309 g of coconut fatty acid (1.50 mol) [EMERY 622, a Cognis product] was added to the polyethyleneimine at temperature of 70-100° C. After the addition, the reaction mixture was slowly heated to 215° C. under N₂ atmosphere. The reaction was then held at 215-220° C. for 6 hours under N₂ flow. Water was removed with N₂ flow. The reaction mixture was then cooled to about 100° C., and the product was then discharged.

### Example 2

### Polyethyleneimine Fatty Acid Amide as Glyphosate Potentiator was Prepared Per the Following Formulation

41.0% Isopropylamine salt of glyphosate 11.0% Emery 6717L (reaction product of polyethyleneimine having a (Mn) 1200 and a mixture of C₆-C₁₂ fatty acids) 48.0% Water

The formulation was diluted with water and applied to the foliage of weeds in a hot humid environment. The formulation containing the reaction product of polyethyleneimine and a mixture of C₆-C₁₂fatty acids improved the efficacy of the salt of glyphosate and increased the rain-fastness of the composition.

What is claimed is:

1: A pesticide composition comprising:
(a) a polyaliphatic amine corresponding to formula I: 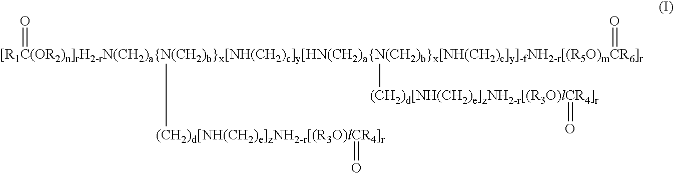
wherein R₁, R₄ and R₆, independently, represent hydrogen or a C₁-C₃₀ alkyl or alkenyl group; (OR₂)ₙ, (OR₃)ₗ and (OR₅)ₘ, independently, represent a random polyalkoxide group, or a block polyalkoxide group; R₂, R₃ and R₅, independently, represent a C₂-C₆ alkyl group; n, m and l, independently, represent a number up to 100, r is a number up to 2; a, b, c, d and e, independently, represent a number from 1-12, x, y and z represent a number up to 100 and f represents a number of from 0 to 49,999;
(b) a biologically active component selected from the group consisting of insecticides, insect repellents, fungicides, bactericides, bacteriostats, herbicides, plant growth regulators, and mixtures thereof; and
(c) optionally carriers and auxiliaries.

2: The composition of claim 1 in the form of a concentrate wherein component (a) is present in an amount of from about 1 to about 40% by weight, and component (b) is present in an amount of from about 3 to about 95% by weight, all weights being based on the weight of the composition.

3: The composition of claim 1 in the form of a concentrate wherein component (a) is present in an amount of from about 4 to about 25% by weight, and component (b) is present in an amount of from about 20 to about 80% by weight, all weights being based on the weight of the composition.

4: The composition of claim 1 in the form of a concentrate wherein component (a) is present in an amount of from about 7 to about 10% by weight, and component (b) is present in an amount of from about 30 to about 65% by weight, all weights being based on the weight of the composition.

5: The composition of claim 1 wherein the polyaliphatic amine comprises polyethyleneimine of the formula (II) wherein f is a number of from 1 to 30.

6: The composition of claim 1 wherein the biologically active component comprises glyphosate.

7: The composition of claim 1 wherein the biologically active component comprises a salt of glyphosate selected from the group consisting of potassium salt, monoethanol amine salt, diethanol amine salts, trimethylsulfonium salt, isopropyl amine salt and mixtures thereof.

8: A process for treating an agricultural substrate comprising contacting the substrate with a biologically active composition comprising:
(a) a polyaliphatic amine of the formula I: 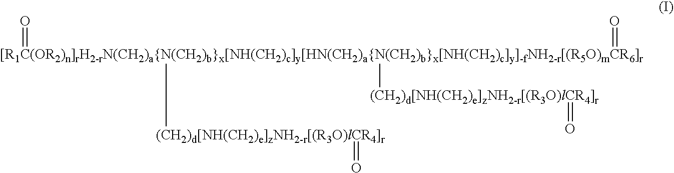
wherein R₁, R₄ and R₆, independently, represent hydrogen or a C₁-C₃₀ alkyl or alkenyl group; (OR₂)ₙ, (OR₃)ₗ and (OR₅)ₘ, independently, represent a random polyalkoxide group, or a block polyalkoxide group; R₂, R₃ and R₅, independently, represent a C₂-C₆ alkyl group; n, m and l, independently, represent a number up to 100, r is a number up to 2; a, b, c, d and e, independently, represent a number from 1-12, x, y and z represent a number up to 100; and f is a number of from 0 to 49,999.
(b) a biologically active component selected from the group consisting of insecticides, insect repellents, fungicides, bactericides, bacteriostats, herbicides, plant growth regulators, and mixtures thereof; and
(c) optionally carriers and auxiliaries.

9: The process of claim 8 wherein component (a) is present in an amount of from about 0.0001% to about 4.0% by weight, and component (b) is present in an amount of from about .00001% to about 9.5% by weight, all weights being based on the weight of the composition.

10: The process of claim 8 wherein component (a) is present in an amount of from about 0.004% to about 2.5% by weight, and component (b) is present in an amount of from about .0001% to about 3.5% by weight, all weights being based on the weight of the composition.

11: The process of claim 8 wherein component (a) is present in an amount of from about 0.01% to about 1% by weight, and component (b) is present in an amount of from about .0015% to about 1.5% by weight, all weights being based on the weight of the composition.

12: The process of claim 8 wherein the polyaliphatic amine is polyethyleneimine of formula (II) wherein f is a member of from 1 to 30.

13: The process of claim 8 wherein the biologically active component is glyphosate.

14: The process of claim 8 wherein the biologically active component comprises a salt of glyphosate selected from the group consisting of potassium salt, monoethanol amine salt, diethanol amine salt, trimethylsulfonium salt, isopropyl amine salt and mixtures thereof.
